(19) United States
(12) Patent Application Publication
(10) Pub. No.: US 2014/0042840 A1
(43) Pub. Date: Feb. 13, 2014

(54) PERMANENT MAGNET (PM) ELECTRIC MACHINE INCLUDING PERMANENT MAGNETS PROVIDED WITH A THERMAL INTERFACE MATERIAL (TIM) BETWEEN ADJACENT PERMANENT MAGNETS

(71) Applicant: Remy Technologies, L.L.C., Pendleton, IN (US)

(72) Inventors: Bradley D. Chamberlin, Pendleton, IN (US); Colin Hamer, Noblesville, IN (US); Koon Hoong Wan, Fishers, IN (US)

(73) Assignee: Remy Technologies, L.L.C., Pendleton, IN (US)

(21) Appl. No.: 13/963,609

(22) Filed: Aug. 9, 2013

Related U.S. Application Data
(60) Provisional application No. 61/681,422, filed on Aug. 9, 2012.

(51) Int. Cl. H02K 9/22; H02K 15/03

(52) U.S. Cl. CPC H02K 9/22; H02K 15/03
USPC 310/52; 29/598

(57) ABSTRACT

A permanent magnet electric machine includes a housing, a stator mounted within the housing, and a rotor assembly rotatably mounted within the housing relative to the stator. The rotor assembly includes a rotor body having a plurality of rotor laminations. A plurality of permanent magnets having axial end portions is mounted to the rotor body. An amount of thermal interface material (TIM) is arranged between the axial end portions of adjacent ones of the plurality of permanent magnets.

### CROSS-REFERENCE TO RELATED APPLICATION

This application is a Non-Provisional of U.S. Provisional Application No. 61/681,422 filed Aug. 9, 2012, the disclosure of which is incorporated by reference herein in its entirety.

### BACKGROUND OF THE INVENTION

Exemplary embodiments pertain to the art of electric machines and, more particularly, to a permanent magnet electric machine including a thermal interface material between adjacent permanent magnets.

Electric machines produce work from electrical energy passing through a stator to induce an electro-motive force in a rotor. The electro-motive force creates a rotational force at the rotor. The rotation of the rotor is used to power various external devices. Of course, electric machines can also be employed to produce electricity from a work input. In either case, electric machines are currently producing greater outputs at higher speeds and are being designed in smaller packages. In the case of permanent magnet electric machines, magnets are being designed to possess a higher flux density in a smaller form-factor. Such magnets generally are formed from, or include, various rare earth metals.

### BRIEF DESCRIPTION OF THE INVENTION

Disclosed is a permanent magnet electric machine including a housing, a stator mounted within the housing, and a rotor assembly rotatably mounted within the housing relative to the stator. The rotor assembly includes a rotor body having a plurality of rotor laminations. A plurality of permanent magnets having axial end portions is mounted to the rotor body. An amount of thermal interface material (TIM) is arranged between the axial end portions of adjacent ones of the plurality of permanent magnets.

Also disclosed is a rotor assembly including a rotor body having a plurality of rotor laminations. A plurality of permanent magnets having axial end portions is mounted to the rotor body. An amount of thermal interface material (TIM) is arranged between the axial end portions of adjacent ones of the plurality of permanent magnets.

Further disclosed is a method of forming a rotor assembly for an electric machine. The method includes stacking a plurality of rotor laminations, joining the plurality of rotor laminations to form a rotor body, mounting a first permanent magnet having a first axial end portion to the rotor body, positioning a thermal interface material at the first axial end portion, mounting a second permanent magnet having a second axial end portion to the rotor body, and positioning the second axial end portion of the second permanent magnet into thermal contact with the first axial end portion of the first permanent magnet through the thermal interface member.

### BRIEF DESCRIPTION OF THE DRAWINGS

The following descriptions should not be considered limiting in any way. With reference to the accompanying drawings, like elements are numbered alike:

FIG. 1 depicts a cross-sectional side view of a permanent magnet electric machine, in accordance with an exemplary embodiment;

FIG. 2 depicts a partially exploded view of a rotor assembly of the permanent magnet electric machine of FIG. 1;

FIG. 3 is a partial view of the rotor assembly of FIG. 2;

FIG. 4 is a partial cross-sectional view of a rotor assembly, in accordance with another aspect of the exemplary embodiment; and

FIG. 5 is a partial cross-sectional view of a rotor assembly, in accordance with yet another exemplary embodiment.

### DETAILED DESCRIPTION OF THE INVENTION

A detailed description of one or more embodiments of the disclosed apparatus and method are presented herein by way of exemplification and not limitation with reference to the Figures.

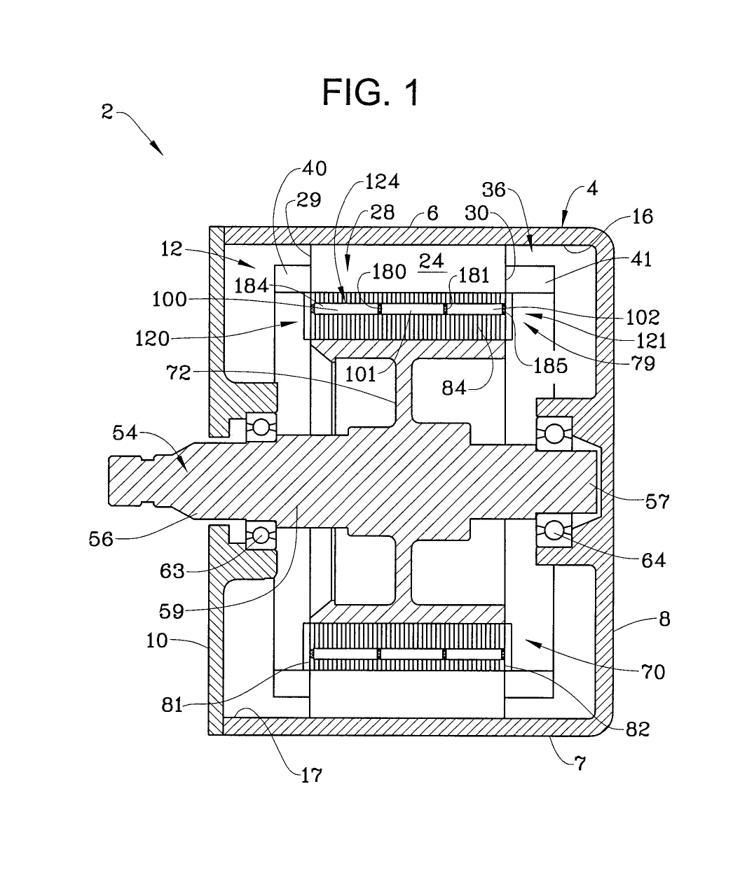

A permanent magnet electric machine in accordance with an exemplary embodiment is indicated generally at 2 in FIG. 1. Electric machine 2 includes a housing 4 having first and second side walls 6 and 7 that are joined by a first end wall 8 and a second end wall or cover 10 to collectively define an interior portion 12. First side wall 6 includes a first inner surface 16 and second side wall 7 includes a second inner surface 17. At this point it should be understood that housing 4 could also be constructed to include a single side wall having a continuous inner surface. Electric machine 2 is further shown to include a stator 24 arranged at first and second inner surfaces 16 and 17 of first and second side walls 6 and 7. Stator 24 includes a body or stator core 28, having a first end portion 29 that extends to a second end portion 30, which supports a plurality of windings 36. Windings 36 include a first end turn portion 40 and a second end turn portion 41.

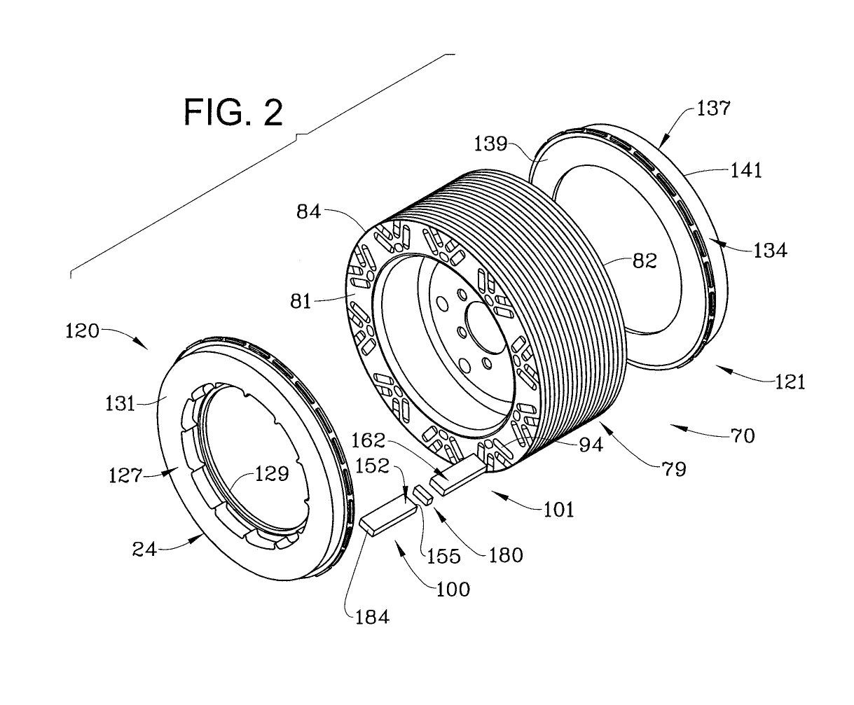

Electric machine 2 is also shown to include a shaft 54 rotatably supported within housing 4. Shaft 54 includes a first end 56 that extends to a second end 57 through an intermediate portion 59. First end 56 is supported at cover 10 through a first bearing 63. Second end 57 is supported to first end wall 8 through a second bearing 64. Shaft 54 supports a rotor assembly 70. Rotor assembly 70 includes a hub 72 that supports a rotor body 79. Rotor body 79 includes a first end portion 81 and an opposing second end portion 82. Rotor body 79 is formed from a plurality of rotor laminations, one of which is indicated at 84. Each rotor lamination 84 includes a plurality of slots, one of which is indicated at 94 in FIG. 2. Rotor laminations 84 are stacked and slots 94 are aligned prior to undergoing a bonding process that forms rotor body 79. A plurality of permanent magnets (PM) 100, 101, and 102 are provided in rotor body 79 in each of the slots 94.

In accordance with one aspect of an exemplary embodiment, electric machine 2 includes a first heat sink ring 120 disposed at first end portion 81 of rotor body 79 and a second heat sink ring 121 disposed at second end portion 82 of rotor body 79. First heat sink ring 120 includes a body 124 having an outer surface 127 and a substantially planar inner surface 129. In the exemplary aspect shown, outer surface 127 includes a substantially planar profile 131. However, it should be understood that outer surface 127 may be provided with various heat exchange devices such as fins. First heat sink ring 120 is supported at first end portion 81 with substantially planar inner surface 129 being in a heat exchange relationship with permanent magnet 100. Second heat sink ring 121 includes a body 134 having an outer surface 137 and a substantially planar inner surface 139. In the exemplary aspect shown, outer surface 137 includes a substantially planar profile 141. However, in a manner similar to that described above, it should be understood that outer surface 137 may be provided with various heat exchange devices such as fins. Second heat sink ring 121 is supported at second end portion 82 with substantially planar inner surface 139 being in a heat exchange relationship with permanent magnet 102. First and second heat sink rings 120, 121 are formed from a thermally conductive material. For example first and second heat sink rings 120 and 121 may be formed from, or include, amounts of aluminum, copper, and/or stainless steel. Of course it should be understood that other thermally conductive material may also be employed. In addition to facilitating heat dissipation, first and second heat sink rings 120 and 121 may also act as balancing elements for rotor assembly 70.

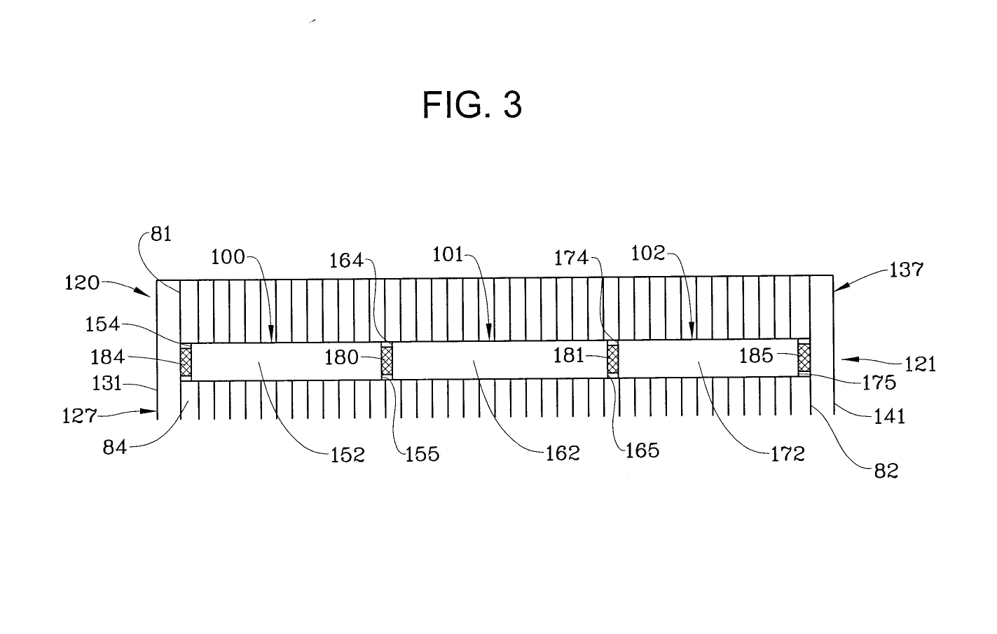

As shown in FIG. 3, permanent magnet 100 includes a magnet body 152 having an outer axial end portion 154 and an inner axial end portion 155. The term “outer axial end portion” should be understood to describe an axial end portion of a permanent magnet that is arranged at an outer end portion of rotor body 79. The term “inner axial end portion” should be understood to describe an axial end portion of a permanent magnet that is contained entirely within rotor body 79. Similarly, permanent magnet 101 includes a magnet body 162 having a first inner axial end portion 164 and a second inner axial end portion 165. Permanent magnet 102 includes a magnet body 172 having an inner axial end portion 174 and an outer axial end portion 175. In the exemplary embodiment shown, outer axial end portion 154 of permanent magnet 100 is arranged at first end portion 81 of rotor body 79 while outer axial end portion 175 of permanent magnet 102 is arranged at second end portion 82 of rotor body 79.

In accordance with another aspect of an exemplary embodiment, electric machine 2 includes a first amount of thermal interface material (TIM) 180 arranged between and abutting inner axial end portion 155 of permanent magnet 100 and first inner axial end portion 164 of permanent magnet 101. A second amount of TIM 181 is arranged between and abuts second axial end portion 164 of permanent magnet 101 and inner axial end portion 174 of permanent magnet 102. First and second amounts of TIM 180,181 establish a thermal flow path through permanent magnets 100,101, and 102 that conducts heat away from magnet bodies 152, 162, and 172.

In accordance with still another aspect of an exemplary embodiment, a third amount of TIM 184 is provided between outer axial end portion 154 of permanent magnet 100 and substantially planar inner surface 139 of first heat sink ring 120. A fourth amount of TIM 185 is provided between outer axial end portion 175 and substantially planar inner surface 141 of second heat sink ring 121. The addition of third and fourth amounts of TIM further enhances removal of heat from magnet bodies 152, 162, and 172. TIM may take on a variety of forms and may include amounts of thermally conductive epoxy resin, alumina (Al₂O₃) filled silicone, graphite paper, boron nitride, beryllium oxide, and/or thermal grease. The TIM may also serve to enhance a bond between permanent magnets 100, 101, and 102 and rotor body 79.

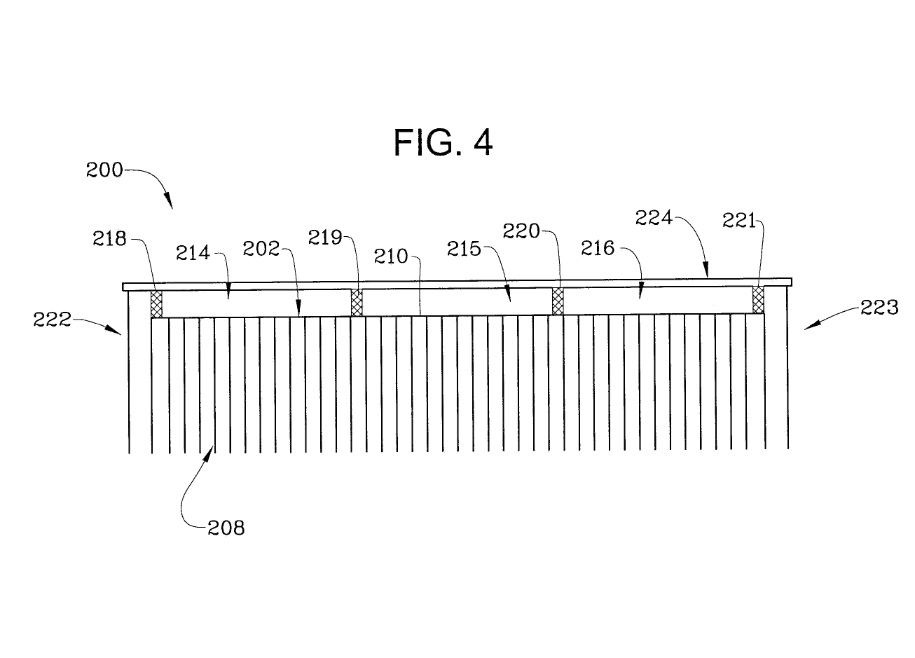

At this point it should be understood that, in addition to permanent magnets mounted in slots provided in the rotor laminations, other permanent magnet mounting arrangements are also contemplated, in accordance with the exemplary embodiment. For example, FIG. 4 illustrates a rotor assembly 200 having a rotor body 202. Rotor body 202 includes a plurality of laminations 208. Laminations 208 form an outer diametric surface 210 of rotor body 202. A plurality of permanent magnets, three of which are indicated at 214, 215, and 216, may be mounted to outer diametric surface 210. Permanent magnets 214, 215 and 216 may be secured to outer diametric surface 210 with a magnet adhesive. TIM 218, 219, 220 and 221 may be arranged at axial end portions (not separately labeled) of each of the plurality of permanent magnets 214, 215, and 216. TIM 218 and 221 provide a thermal interface between permanent magnets 214 and 216 and respective heat sink rings 222 and 223. As discussed above, in addition to facilitating heat removal, heat sink rings 222 and 223 may also act as balancing members for rotor assembly 200. In addition, an outer, radial, sleeve 224 may be provided about rotor body 202.

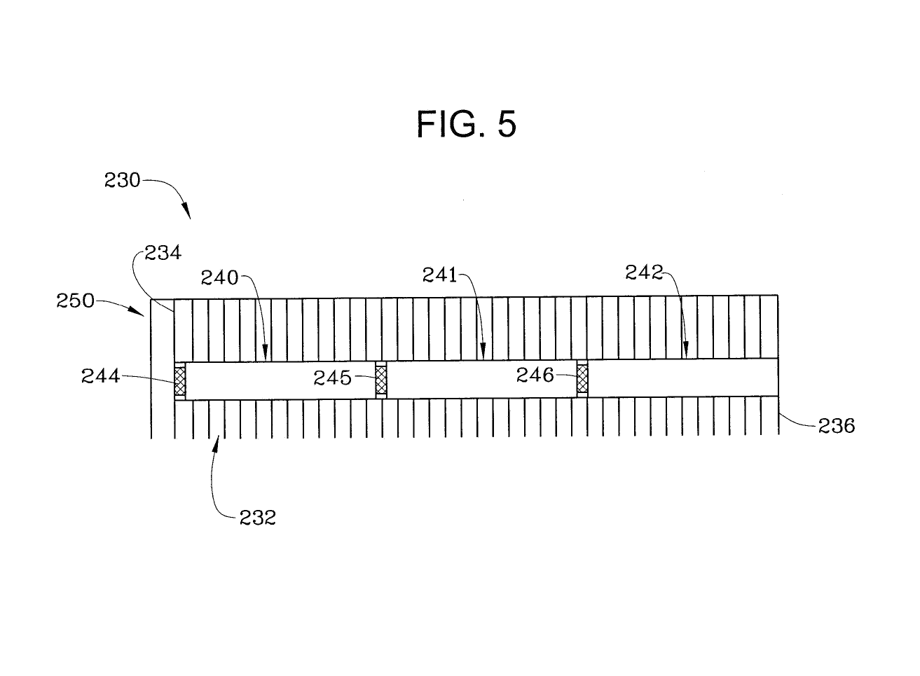

FIG. 5 illustrates a rotor assembly 230 having a rotor body 231 formed from a plurality of laminations 232. Rotor body 231 extends from a first end portion 234 to a second end portion 236. A plurality of permanent magnets, three of which are shown at 240, 241, and 242 are mounted to rotor body 230 in slots (not separately labeled) formed in each of the plurality of laminations 232. TIM 244, 245, and 246 is mounted at axial end portions of respective ones of permanent magnets 240-242. In the exemplary embodiment shown, rotor body includes a single heat sink ring 250 mounted at first end portion 234. In addition to promoting heat removal, heat sink ring 250 may also act as a balancing member for rotor assembly 230. TIM 244 is mounted between heat sink ring 250 and an axial end portion (not separately labeled) of permanent magnet 240. Of course it should be understood that heat sink ring 250 may, in the alternative, be mounted at second end portion 236. It should also be understood, that if only a single heat sink ring is employed, an outer axial end portion (not separately labeled) of permanent magnet 242 may be devoid of TIM.

At this point it should be understood that the exemplary embodiments provide a system for removing heat from permanent magnets supported in a rotor of a permanent magnet electric machine. Over time, magnetic strength of permanent magnets in electric machines lessens. Surprisingly, it has been found that by lowering temperatures of the permanent magnets, the loss of magnetic strength may be delayed or even substantially arrested. Enhancing the life of permanent magnets reduces maintenance costs by delaying the need for rotor replacement. In addition, lowering temperatures in the permanent magnets provides opportunities to employ lower amounts of rare earth metals in magnet construction. Reducing the amount of rare earth metals used to form permanent magnets leads to a reduction in cost of the electric motor.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims.

What is claimed is:

1. A permanent magnet electric machine comprising:
a housing;
a stator mounted within the housing; and
a rotor assembly rotatably mounted within the housing relative to the stator, the rotor assembly including a rotor body having plurality of rotor laminations, a plurality of permanent magnets having axial end portions mounted to the rotor body, and an amount of thermal interface material (TIM) arranged between the axial end portions of adjacent ones of the plurality of permanent magnets.

2. The permanent magnet electric machine according to claim 2, wherein the rotor body extends from a first end portion to a second end portion, a heat sink ring is mounted to one of the first end portion and the second end portion.

3. The permanent magnet electric machine according to claim 2, wherein the heat sink ring includes an outer surface and a substantially planar inner surface arranged in thermal communication with an outer axial end portion of one of the plurality of permanent magnets.

4. The permanent magnet electric machine according to claim 3, further comprising: an amount of thermal interface material between the substantially planar inner surface of the heat sink ring and the outer axial end portion of the one of the plurality of permanent magnets.

5. The permanent magnet electric machine according to claim 3, wherein the outer surface of the heat sink ring includes a substantially planar profile.

6. The permanent magnet electric machine according to claim 2, wherein the heat sink ring is formed from a thermally conductive material.

7. The permanent magnet electric machine according to claim 1, wherein each of the plurality of laminations includes a plurality of slots, at least one of the plurality of permanent magnets being arranged in one of the plurality of slots of one or more of the plurality of laminations.

8. A rotor assembly comprising:
a rotor body having plurality of rotor laminations;
a plurality of permanent magnets having axial end portions mounted relative to the rotor body; and
an amount of thermal interface material (TIM) arranged between the axial end portions of adjacent ones of the plurality of permanent magnets.

9. The rotor assembly according to claim 8, wherein the rotor body includes a first end portion and a second end portion, a heat sink ring is mounted to one of the first end portion and the second end portion.

10. The rotor assembly according to claim 9, wherein the heat sink ring includes an outer surface and a substantially planar inner surface arranged in thermal communication with an outer axial end portion of one of the plurality of permanent magnets.

11. The rotor assembly according to claim 10, further comprising: an amount of TIM between the substantially planar inner surface of the heat sink ring and the outer axial end portion of the one of the plurality of permanent magnets.

12. The rotor assembly according to claim 10, wherein the outer surface of the heat sink ring includes a substantially planar profile.

13. The rotor assembly according to claim 9, wherein the heat sink ring is formed from a thermally conductive material.

14. The rotor assembly according to claim 9, wherein each of the plurality of laminations includes a plurality of slots, at least one of the plurality of permanent magnets being arranged in one of the plurality of slots of one or more of the plurality of laminations.

15. A method of forming a rotor assembly for an electric machine, the method comprising:
stacking a plurality of rotor laminations;
joining the plurality of rotor laminations to form a rotor body;
mounting a first permanent magnet having a first axial end portion to the rotor body;
positioning a thermal interface material (TIM) at the first axial end portion;
mounting a second permanent magnet having a second axial end portion to the rotor body; and
positioning the second axial end portion of the second permanent magnet into thermal contact with the first end portion of the first permanent magnet through the TIM.

16. The method of claim 15 further comprising: positioning a heat sink ring on an end portion of the rotor body.

17. The method of claim 16, further comprising: positioning a TIM between an outer axial end portion of the first magnet and an inner surface of the heat sink ring.

18. The method of claim 16, further comprising: positioning another heat sink ring on another end portion of the rotor body.

19. The method of claim 18, further comprising: positioning another TIM between an outer axial end portion of the second permanent magnet and an inner surface of the another heat sink ring.

20. The method of claim 15, further comprising:
aligning a plurality of slots on each of the plurality of laminations; and
inserting the first and second permanent magnets into one of the plurality of slots of one or more of the plurality of laminations.
